(19) United States
(12) Patent Application Publication
(10) Pub. No.: US 2024/0059969 A1
(43) Pub. Date: Feb. 22, 2024

(54) ENVIRONMENTALLY FRIENDLY ADDITIVES

(71) Applicant: UNIQUEM INC., Calgary (CA)

(72) Inventors: Amir A. MIRZAEI, Toronto (CA); Hirbod RAD, Calgary (CA)

(21) Appl. No.: 18/264,736

(22) PCT Filed: Feb. 8, 2021
(86) PCT No.: PCT/CA2021/050139

§ 371 Date: Aug. 8, 2023

(51) Int. Cl. C09K 15/20; C09K 15/06; C09K 5/00; C09K 8/54; C09K 8/08; C23F 11/173; E21B 41/02

(52) U.S. Cl. CPC C09K 15/20; C09K 15/06; C09K 5/00; C09K 8/54; C09K 8/08; C23F 11/173; E21B 41/02; C09K 2208/32

(57) ABSTRACT

Described herein is a corrosion inhibitor for use in an aqueous brine solution; the brine solution may be a drilling fluid or refrigeration fluid. The corrosion inhibitor comprises a reducing sugar, such as a monosaccharide, a disaccharide, a polysaccharide, or any combination thereof. A method of drilling a borehole is also described; the method comprises injecting a drilling fluid into the borehole, wherein the drilling fluid comprises an aqueous brine solution comprising a reducing sugar as a corrosion inhibitor.

### FIELD

The present invention relates to corrosion inhibitors. More specifically, the present invention is, in aspects, concerned with corrosion inhibitors for use in aqueous brine solutions and related compositions and methods.

### BACKGROUND

Corrosion occurs when metals are oxidized to their respective ions or insoluble salts. For example, corrosion of metallic iron involves conversion to soluble iron to a +2 or +3 oxidation state or to formation of insoluble iron oxides and hydroxides. Metal loss from the solubilization of the iron can cause the structural integrity of the system to deteriorate over time. This can cause leakage between the water system and process streams. Also, the formation of insoluble salts in the corrosion process can produce a build-up of deposits which impede heat transfer and fluid flow.

Corrosion of metallic surfaces in contact with brine-based drilling fluids, such as drill strings and tubulars during drilling is a costly problem. Such metallic surfaces are typically composed of carbon steels, ferritic alloy steels, and high alloy steels including chrome steels, duplex steels, stainless steels, martensitic alloy steels, austenitic stainless steels, precipitation-hardened stainless steels, and high nickel content steels.

Solid-free brines, commonly used in drilling and completion fluids, are typically high-density brines. Such brines, especially higher density brines (like calcium chloride, calcium bromide, zinc bromide and mixtures thereof), have a high salt content and thus are highly corrosive. High corrosivity may be noticed, for instance, when such brines are used as packer fluids since they remain in contact with production tubing and casing for an extended period.

The high corrosivity demonstrated by use of such high-density brines may cause costly and sometimes hazardous failures of drill strings and tubulars. Conventionally, a corrosion inhibitor or a corrosion inhibitor package is added to the brine to prevent or minimize brine corrosion on such metallic surfaces. Typically, the corrosion inhibitor or corrosion inhibitor package is used as an additive to the brine-based drilling fluids as well as packer fluids.

In another application, aqueous brine solutions are commonly used as refrigeration media. The same corrosion concerns and patterns have been recorded in air-conditioning industry as the main user of refrigeration media. Therefore, to reduce the extent of corrosion when brine solutions are used as refrigeration media, corrosion inhibitors typically are added to the brine solutions.

Chromates used to be the best viable solution to water and brine-based corrosion for the decades prior to 1970 and were traditionally widely used as effective corrosion inhibitors. During the 1970s to 1980s, however, the use of chromate came under increasing scrutiny due to environmental concerns. Unfortunately, phosphates, which are generally excellent corrosion inhibitors as well, are undesirable in this application since they lead to unacceptable levels of scale formation. Similarly, nitrites may also not be used since they change the nature of corrosion from general corrosion to localized corrosion and pitting.

The literature is abundant in attempts to find the optimum balance between environmental concerns and corrosion inhibition efficiency. For example, U.S. Pat. No. 7,837,931 uses at least one C2-C12 acetylenic alcohol or amine or a halide or nitrate salt derivative thereof and a solubilized transition metal oxide. The problem with acetylenic alcohols and amines is that most of those compounds and their derivatives are toxic to the environment and carcinogenic to humans.

In U.S. patent Ser. No. 10/323,327, the corrosion inhibitor includes at least one azole, at least one polypeptide derived from amino acid, at least one intensifier preferably from metal halides, and at least one surfactant. While this is more friendly to the environment and humans, foaming is a major concern when used in drilling fluids.

Other Corrosion inhibitors conventionally used include different types of fatty acid derivatives, imidazoles and their derivatives, quaternary ammonium salts, sulfur-containing products like thiocyanates, thioglycols and thioureas, as well as oxygen scavengers (sulfite, erythorbate (Halliburton)-DEHA (CES)) and phosphonates and gluconates.

Of the above-mentioned categories of corrosion inhibitors, two types which have gained considerable market dominance are: film-forming amines and low molecular weight inorganic thiocyanate (SCN—) compounds. Film-forming amine inhibitors are often more effective when used at temperatures below 250° F. while the low-molecular weight inorganic thiocyanate inhibitors typically provide corrosion protection up to 350° F. but were found to cause chloride and sulfide stress cracking corrosion.

Even when no hydrogen sulfide is produced in the well, the thermal decomposition of sulfur-containing inhibitors may lead to sulfur-related stress corrosion cracking. Such inhibitors decompose at elevated bottomhole temperatures and release hydrogen sulfide. The release of hydrogen sulfide as a decomposition product is believed to induce sulfide stress corrosion cracking of the alloy tubulars.

It is clear that there is a need for novel corrosion inhibitors in brine solution systems.

### SUMMARY

In accordance with an aspect, there is provided a range of corrosion inhibiting products with excellent protection of drilling equipment in contact with brine-based drilling fluids.

In accordance with an aspect, there is provided a corrosion inhibitor for an aqueous brine solution, the corrosion inhibitor comprising a reducing sugar.

In an aspect, the reducing sugar comprises a monosaccharide, a disaccharide, a polysaccharide, or any combination thereof.

In an aspect, the reducing sugar comprises glucose, glucosamine, acetyl glucosamine, fructose, sucrose, lactose, maltose, cellobiose, galactose, mannose, ribose, ribulose, xylose, lyxose, rhamnose, arabinose, erythrose, or any combination thereof.

In an aspect, the reducing sugar is present in an amount sufficient to inhibit general and/or localized corrosion.

In an aspect, the reducing sugar is present in an amount of from about 200 to about 20,000 ppm by weight of the aqueous brine solution.

In an aspect, the reducing sugar is present in an amount of about 2500 ppm by weight of the aqueous brine solution.

In an aspect, the reducing sugar is present in an amount of about 5000 ppm by weight of the aqueous brine solution.

In accordance with an aspect, there is provided an aqueous brine solution comprising the corrosion inhibitor described herein.

In an aspect, the solution is a refrigeration solution.

In an aspect, the solution is a drilling solution.

In an aspect, the solution comprises water, soluble metal salts, weight agents such as barite and/or hematite, rheology modifiers, such as bentonite and/or xanthan gum, fluid loss and lost circulation materials, such as walnut shell powder, starch, and/or polyanionic cellulose, oxygen scavengers, hydrogen sulfide scavengers, emulsifiers, demulsifiers, scale inhibitors, coagulants, biocides, flocculants, surfactants, shale and clay inhibitors, viscosifiers, lubricants, or combinations thereof.

In an aspect, the solution has a pH of from about 6 to about 12.

In an aspect, the solution has a pH of from about 6.5 to about 11.

In an aspect, the solution has a pH of from about 7.5 to about 10.5.

In an aspect, the temperature of the solution is less than about 250 C.

In an aspect, the temperature of the solution is less than about 150 C.

In an aspect, the temperature of the solution is less than about 90 C.

In an aspect, the solution further comprises a buffering agent.

In an aspect, the solution further comprises an alkalinizing agent.

In an aspect, the solution further comprises finely divided or colloidal filter cake forming solids.

In accordance with an aspect, there is provided a reducing sugar for use in an aqueous brine solution, such as a drilling fluid or refrigeration fluid.

In accordance with an aspect, there is provided a use of a reducing sugar in an aqueous brine solution, such as a drilling fluid or refrigeration fluid.

In accordance with an aspect, there is provided a method of drilling, the method comprising injecting the drilling fluid described herein into a borehole.

Other features and advantages of the present invention will become apparent from the following detailed description. It should be understood, however, that the detailed description and the specific examples while indicating embodiments of the invention are given by way of illustration only, since various changes and modifications within the spirit and scope of the invention will become apparent to those skilled in the art from said detailed description.

### DETAILED DESCRIPTION

### Definitions

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” (or vice versa) wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effects described herein. For example, a composition defined using the phrase “consisting essentially of” encompasses any known pharmaceutically acceptable additive, excipient, diluent, carrier, and the like. Typically, a composition consisting essentially of a set of components will comprise less than 5% by weight, typically less than 3% by weight, more typically less than 1% by weight of non-specified components.

The term “reducing sugar” has been described herein with reference to certain specific examples. It will be understood that any reducing sugar is contemplated for use herein, provided the reducing sugar is useful as a corrosion inhibitor in an aqueous brine solution.

It will be understood that any component defined herein as being included may be explicitly excluded by way of proviso or negative limitation, such as any specific compounds or method steps, whether implicitly or explicitly defined herein.

In addition, all ranges given herein include the end of the ranges and also any intermediate range points, whether explicitly stated or not.

Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

### Compositions and Methods

Described herein are novel corrosion inhibitors for use with high density brines which can control, reduce, or inhibit the corrosion caused by brine-based drilling fluids without the associated environmental costs and the technical shortcomings of conventional corrosion inhibitors.

In aspects, the corrosion inhibitors described herein are environmentally acceptable, economical, and will inhibit corrosion.

More particularly, described herein are corrosion inhibitors and methods of inhibiting corrosion in brine solution systems. In aspects, the method comprises treating an aqueous brine solution and more typically brine based drilling fluids with reducing sugars. The use of reducing sugars is environmentally acceptable, economically appealing, and effectively inhibits general and localized corrosion.

It is described herein that reducing sugars are highly effective in inhibiting corrosion in brine solutions and more specifically in brine-based drilling fluids. Reducing sugars are carbohydrates that can be easily oxidized by weak oxidizing agents in basic aqueous solution. From the corrosion inhibiting property aspect of the current application, the main characteristic property of reducing sugars is that, in aqueous medium, they generate one or more compounds containing an aldehyde group.

All monosaccharides are reducing sugars, along with some disaccharides, some oligosaccharides, and some polysaccharides. The monosaccharides can be divided into two groups: the aldoses, which have an aldehyde group, and the ketoses, which have a ketone group. Ketoses must first tautomerize to aldoses before they can act as reducing sugars. The common dietary monosaccharides galactose, glucose and fructose are all examples of reducing sugars.

For example, a-D-glucose, which contains a hemiacetal group and, therefore, reacts with water to give an open-chain form containing an aldehyde group, is a reducing sugar. This reaction scheme is shown below.

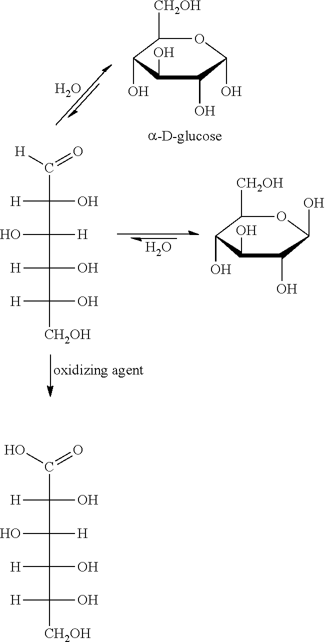

In another example, a-D-fructose, which contains a hemiketal group and, therefore, reacts with water to generate an open-chain form, which, in basic medium, is converted to compounds containing an aldehyde group, is another reducing sugar. This reaction scheme is shown below.

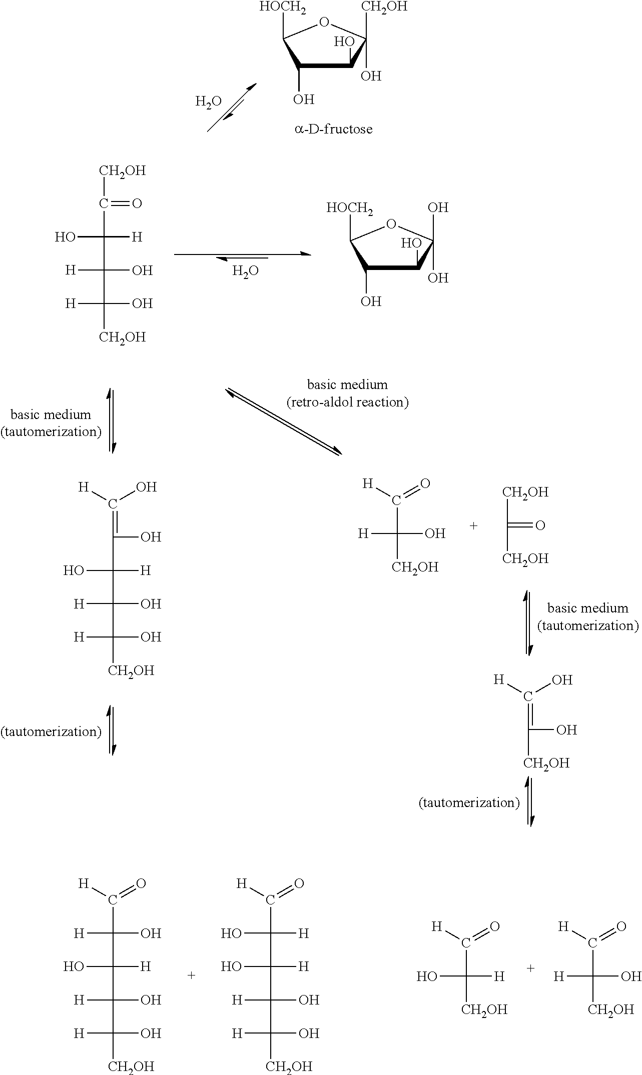

Thus, described here are corrosion inhibitors for aqueous brine solutions. The corrosion inhibitor comprises a reducing sugar. It will be understood that any and all reducing sugars are encompassed herein. Certain examples are given by way of further explanation but are not limiting. In aspects, the reducing sugars are considered environmentally friendly. In additional or alternative aspects, the reducing sugars are considered safe. In additional or alternative aspects, the reducing sugars are suitable for use in a drilling fluid or drilling operation. In additional or alternative aspects, the reducing sugars are biodegradable.

As described herein, the reducing sugar may be any reducing sugar but typically comprises a monosaccharide, a disaccharide, a polysaccharide, or any combination thereof. Non-limiting examples of reducing sugars include glucose, glucosamine, acetyl glucosamine, fructose, sucrose, lactose, maltose, cellobiose, galactose, mannose, ribose, ribulose, xylose, lyxose, rhamnose, arabinose, erythrose, or any combination thereof.

The reducing sugar may be present in the aqueous brine in any desired quantity. The reducing sugar is typically present in an amount sufficient to inhibit general and/or localized corrosion. For example, the reducing sugar is present in an amount of from about 200 to about 20,000 ppm by weight of the aqueous brine solution. Such as about 2500 ppm or about 5000 ppm. Such as from about 200, about 500, about 1000, about 1500, about 2000, about 2500, about 3000, about 3500, about 4000, about 4500, about 5000, about 5500, about 6000, about 6500, about 7000, about 8500, about 9000, about 9500, about 10000, about 10500, about 11000, about 11500, about 12000, about 12500, about 13000, about 13500, about 14000, about 14500, about 15000, about 15500, about 16000, about 16500, about 17000, about 18500, about 19000, or about 19500, to about 500, about 1000, about 1500, about 2000, about 2500, about 3000, about 3500, about 4000, about 4500, about 5000, about 5500, about 6000, about 6500, about 7000, about 8500, about 9000, about 9500, about 10000, about 10500, about 11000, about 11500, about 12000, about 12500, about 13000, about 13500, about 14000, about 14500, about 15000, about 15500, about 16000, about 16500, about 17000, about 18500, about 19000, about 19500, or about 20000 ppm.

In other aspects, the reducing sugar may be present in the aqueous brine solution in an amount from about 0.01% to about 95% w/w or v/v, such as from about 0.01%, about 0.1%, about 1%, about 5%, about 10%, about 15%, about 20%, about 25%, about 30%, about 35%, about 40%, about 45%, about 50%, about 60%, about 65%, about 70%, about 75%, about 80%, about 85%, or about 90% to about 0.1%, about 1%, about 5%, about 10%, about 15%, about 20%, about 25%, about 30%, about 35%, about 40%, about 45%, about 50%, about 60%, about 65%, about 70%, about 75%, about 80%, about 85%, about 90%, or about 95% w/w or w/v.

Typically, the reducing sugar is safe and easy to use and can be added to an aqueous brine solution at a drilling site. In this way, the reducing sugar can be used as needed and added in desired quantities depending on the drilling needs.

The reducing sugars described herein may be used in any aqueous brine solution, however, typically, the aqueous brine solution is a brine-based drilling fluid. In alternative examples, the aqueous brine solution may be a refrigeration solution.

Aqueous brine solutions may contain many different excipients or additional components to assist in obtaining desirable properties. For example, the aqueous brine solutions used for drilling fluids in aspects comprise water, soluble metal salts, weight agents such as barite and/or hematite, rheology modifiers, such as bentonite and/or xanthan gum, fluid loss and lost circulation materials, such as walnut shell powder, starch, and/or polyanionic cellulose, oxygen scavengers, hydrogen sulfide scavengers, emulsifiers, demulsifiers, scale inhibitors, coagulants, biocides, flocculants, surfactants, shale and clay inhibitors, viscosifiers, lubricants, or combinations of any of these components. The aqueous brine solution in aspects comprises a finely divided or colloidal filter cake forming solids. In additional or alternative aspects, the aqueous brine solution comprises a buffering agent and/or an alkalinizing agent.

The aqueous brine solution typically has a pH that is from about 6 to about 12, such as from about 6.5 to about 11, such as from about 7.5 to about 10.5. In aspects, the pH is from about 6, about 6.5, about 7, about 7.5, about 8, about 8.5, about 9, about 9.5, about 10, about 10.5, about 11, or about 11.5 to about 6.5, about 7, about 7.5, about 8, about 8.5, about 9, about 9.5, about 10, about 10.5, about 11, about 11.5, or about 12. The pH is typically adjusted to a desirable level through inclusion of a basic material in the aqueous brine solution.

The aqueous brine solution can be used at any temperature. Typically, however, the aqueous brine solution is used a temperature of less than about 200 C. For example, less than about 120 C or less than 70 C. In aspects, the temperature is less than about 200 C, less than about 175 C, less than about 150 C, less than about 125 C, less than about 100 C, less than about 90 C, less than about 80 C, less than about 70 C, less than about 60 C, less than about 50 C, or less than about 40 C.

In additional aspects, a method for drilling, such as for drilling a borehole, is described herein. The method comprises drilling a borehole and injecting the aqueous brine solution described herein into the borehole.

The above disclosure generally describes the present invention. A more complete understanding can be obtained by reference to the following specific Examples. These Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLES

### Example 1

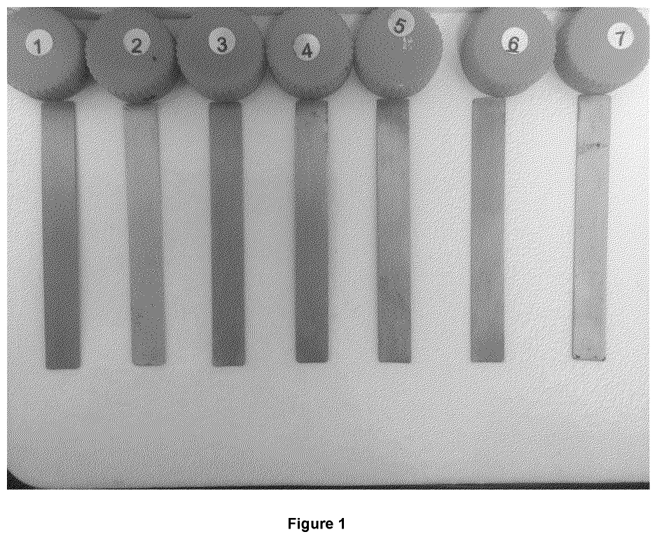

A typical calcium chloride-based drilling fluid was made with 35% calcium chloride dissolved in water. The fluid was Ph adjusted to 10 by the addition of calcium hydroxide. Results are shown in the table below and in FIG. 1. It is clear that each of the reducing sugars tested worked better than control and better than the comparative conventional corrosion inhibitors.

| | Initial weight | Final weight | Delta | MPY |
|---|---|---|---|---|
| Glucosamine | 8.598 | 8.588 | 0.01 | 0.8 |
| D-Fructose | 8.585 | 8.574 | 0.011 | 0.9 |
| Maltose | 8.591 | 8.573 | 0.018 | 1.5 |
| Sucrose | 8.58 | 8.469 | 0.11 | 16 |
| CI-1 | 8.582 | 8.551 | 0.031 | 2.5 |
| CI-2 | 8.656 | 8.624 | 0.032 | 2.6 |
| Blank | 8.582 | 8.242 | 0.34 | 28 |

Test temperature: 60-65 C.
Test duration: 72 hours
CI-1 was a commercial inhibitor based on film forming amine
CI-2 was a commercial green inhibitor with no ingredients to be reported on the SDS
Blank contained calcium hydroxide for Ph adjustment only

The above disclosure generally describes the present invention. Although specific terms have been employed herein, such terms are intended in a descriptive sense and not for purposes of limitation.

All publications, patents and patent applications cited above are herein incorporated by reference in their entirety to the same extent as if each individual publication, patent or patent application was specifically and individually indicated to be incorporated by reference in its entirety.

Although preferred embodiments of the invention have been described herein in detail, it will be understood by those skilled in the art that variations may be made thereto without departing from the spirit of the invention or the scope of the appended claims.

1. A corrosion inhibitor for an aqueous brine solution, the corrosion inhibitor comprising a reducing sugar.

2. The corrosion inhibitor of claim 1, wherein the reducing sugar comprises a monosaccharide, a disaccharide, a polysaccharide, or any combination thereof.

3. The corrosion inhibitor of claim 2, wherein the reducing sugar comprises glucose, glucosamine, acetyl glucosamine, fructose, sucrose, lactose, maltose, cellobiose, galactose, mannose, ribose, ribulose, xylose, lyxose, rhamnose, arabinose, erythrose, or any combination thereof.

4. The corrosion inhibitor of any one of claims 1 to 3, wherein the reducing sugar is present in an amount sufficient to inhibit general and/or localized corrosion.

5. The corrosion inhibitor of any one of claims 1 to 4, wherein the reducing sugar is present in an amount of from about 200 to about 20,000 ppm by weight of the aqueous brine solution.

6. The corrosion inhibitor of claim 5, wherein the reducing sugar is present in an amount of about 2500 ppm by weight of the aqueous brine solution.

7. The corrosion inhibitor of claim 5, wherein the reducing sugar is present in an amount of about 5000 ppm by weight of the aqueous brine solution.

8. An aqueous brine solution comprising the corrosion inhibitor of any one of claims 1 to 7.

9. The solution of claim 8, wherein the solution is a refrigeration solution.

10. The solution of claim 8, wherein the solution is a drilling solution.

11. The solution of claim 10, comprising water, soluble metal salts, weight agents such as barite and/or hematite, rheology modifiers, such as bentonite and/or xanthan gum, fluid loss and lost circulation materials, such as walnut shell powder, starch, and/or polyanionic cellulose, oxygen scavengers, hydrogen sulfide scavengers, emulsifiers, demulsifiers, scale inhibitors, coagulants, biocides, flocculants, surfactants, shale and clay inhibitors, viscosifiers, lubricants, or combinations thereof.

12. The solution of any one of claims 8 to 11, wherein the solution has a pH of from about 6 to about 12.

13. The solution of claim 12, wherein the solution has a pH of from about 6.5 to about 11.

14. The solution of claim 13, wherein the solution has a pH of from about 7.5 to about 10.5.

15. The solution of any one of claims 8 to 14, wherein the temperature of the solution is less than about 250 C.

16. The solution of claim 15, wherein the temperature of the solution is less than about 150 C.

17. The solution of claim 16, wherein the temperature of the solution is less than about 90 C.

18. The solution of any one of claims 8 to 17, further comprising a buffering agent.

19. The solution of any one of claims 8 to 18, further comprising an alkalinizing agent.

20. The solution of any one of claims 8 to 19, further comprising finely divided or colloidal filter cake forming solids.

21. A reducing sugar for use in an aqueous brine solution, such as a drilling fluid or refrigeration fluid.

22. Use of a reducing sugar in an aqueous brine solution, such as a drilling fluid or refrigeration fluid.

23. A method of drilling, the method comprising injecting the drilling fluid of any one of claims 8 to 20 into a borehole.
